(19) United States
(12) Patent Application Publication
(10) Pub. No.: US 2016/0134672 A1
(43) Pub. Date: May 12, 2016

(54) DELIVERING PARTIALLY RECEIVED SEGMENTS OF STREAMED MEDIA DATA

(71) Applicant: QUALCOMM Incorporated, San Diego, CA (US)

(72) Inventors: Osama Abdel Latif Lotfallah, San Diego, CA (US); Ralph Akram Gholmieh, San Diego, CA (US); Nagaraju Naik, San Diego, CA (US); Carlos Marcelo Dias Pazos, Carlsbad, CA (US); Nermeen Ahmed Bassiouny, San Diego, CA (US); Nagaraja Shivashankar, San Diego, CA (US); Thadi Manjunath Nagaraj, San Diego, CA (US)

(21) Appl. No.: 14/861,368

(22) Filed: Sep. 22, 2015

Related U.S. Application Data
(60) Provisional application No. 62/078,322, filed on Nov. 11, 2014.

(51) Int. Cl. H04L 29/06; H04L 29/08

(52) U.S. Cl. CPC H04L 65/60; H04L 67/02

(57) ABSTRACT

In one example, a client device for receiving media data includes a streaming client and a middleware unit. The middleware unit is configured to receive a first portion of data of a current segment of media data, wherein file delivery information for the current segment indicates that transmission of the data for the current segment will end at a first time, determine, prior to the first time, that a remaining portion of the data of the current segment will not be received, and, based on the determination, deliver at least some of the first portion of data to the streaming client.

This application claims the benefit of U.S. Provisional Application Ser. No. 62/078,322, filed Nov. 11, 2014, the entire contents of which are hereby incorporated by reference.

### TECHNICAL FIELD

This disclosure relates to storage and transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this application for delivering partially received media segments to a streaming client. That is, rather than discarding partially received media segments, the techniques of this disclosure allow partially received media segments to be delivered to a streaming client. The streaming client can then use as much media data of the received segments as can be extracted, which may provide a better user experience than if none of the data from the media segments were used at all.

In one example, a method of delivering media data from a middleware unit of a client device to a streaming client of the client device includes, by the middleware unit: receiving a first portion of data of a current segment of media data, wherein file delivery information for the current segment indicates that transmission of the data for the current segment will end at a first time, prior to the first time, determining that a remaining portion of the data of the current segment will not be received, and based on the determination, delivering at least some of the first portion of data to the streaming client.

In another example, a client device for receiving media data includes a streaming client and a middleware unit. The middleware unit is configured to receive a first portion of data of a current segment of media data, wherein file delivery information for the current segment indicates that transmission of the data for the current segment will end at a first time, determine, prior to the first time, that a remaining portion of the data of the current segment will not be received, and based on the determination, deliver at least some of the first portion of data to the streaming client.

In another example, a client device for delivering media data to a streaming client of the client device includes means for receiving a first portion of data of a current segment of media data, wherein file delivery information for the current segment indicates that transmission of the data for the current segment will end at a first time, means for determining, prior to the first time, that a remaining portion of the data of the current segment will not be received, and means for delivering, based on the determination, at least some of the first portion of data to the streaming client.

In another example, a computer-readable storage medium has stored thereon instructions that, when executed, cause a processor of a client device to receive a first portion of data of a current segment of media data, wherein file delivery information for the current segment indicates that transmission of the data for the current segment will end at a first time, prior to the first time, determine that a remaining portion of the data of the current segment will not be received, and based on the determination, deliver at least some of the first portion of data to a streaming client of the client device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of the retrieval unit of FIG. 1 in greater detail.

FIG. 3 is a conceptual diagram illustrating elements of example multimedia content.

FIG. 4 is a conceptual diagram illustrating an example technique in which a broadcast multicast service center (BM-SC), such as the server device of FIG. 1, sends a file delivery table (FDT) relatively frequently.

FIGS. 5A and 5B are graphs representing analyses of overhead associated with sending an FDT multiple times.

FIG. 6 is a block diagram illustrating example contents of a segment.

FIG. 7 is a conceptual diagram illustrating examples in which a BM-SC repeats the first few encoding symbol identifiers ESI(s) of a multicast channel (MCH) scheduling period (MSP).

FIG. 8 is a conceptual diagram illustrating examples in which the BM-SC repeats sending of key frames.

FIG. 9 is a conceptual diagram illustrating an example technique by which an Enhanced Multimedia Broadcast Multicast Service (eMBMS) middleware unit may detect an incomplete segment reception using a transport object identifier (TOI).

FIG. 10 is a conceptual diagram illustrating an example technique by which an eMBMS middleware unit may detect incomplete segment reception.

FIG. 11 is a conceptual diagram illustrating an example technique by which an eMBMS middleware unit may detect an incomplete segment reception using a processing margin.

FIG. 12 is a conceptual diagram illustrating an example in which an eMBMS middleware sets a deadline to trigger partial segment recovery.

FIG. 13 is a flowchart illustrating an example method for transmitting and receiving media data in accordance with the techniques of this disclosure.

### DETAILED DESCRIPTION

In general, this disclosure describes techniques for improving a user's experience when dynamic adaptive streaming over HTTP (DASH) segments are only partially received by a client device. Partial DASH segment reception may occur as a result of, for example, switching between media programs (tune-away) or radio channel errors. Various techniques of this disclosure are based on the recognition that media data of a partially received DASH segment may still be playable, and that playing such media data may result in a better user experience than, for example, simply presenting a blank screen and/or silent audio. That is, a media player may be able to play most of the correctly received portions of a segment, which may minimize playback interruption, especially for large segments.

In order to provide media data of a partially received DASH segment to a media player, this disclosure describes techniques that may be used by a broadcast transmission system (e.g., a Broadcast Multimedia Service Center (BM-SC)), a middleware unit, and a streaming client such as a DASH client, such that each of these components may be configured to operate cooperatively. The middleware unit and the DASH client may be included within a client device. In this manner, partially received DASH segments may be efficiently delivered to a media player of the client device. In other examples, a streaming client may comprise an Apple HTTP Live Streaming (HLS) client or a Microsoft Smooth Streaming client.

One potential solution regarding partially received DASH segments is to prevent errors from occurring in the first place. For instance, a BM-SC may utilize enhanced transmission techniques to compact potential losses, such as by applying forward error correction (FEC) to DASH segments. However, FEC techniques might not be suitable to provide different levels of protection for different parts of media packets, since some portions of a media segment are more important than others. Thus, this disclosure describes techniques in which a middleware unit or other unit of a client device attempts to recover most of the correctly received portion of a media segment. Furthermore, this disclosure describes various techniques that may be performed by DASH clients and BM-SCs related to delivery of partially received DASH segments.

In DASH, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more periods. Periods may be defined by a Period element in the MPD. Each period may have an attribute start in the MPD. The MPD may include a start attribute and an availableStartTime attribute for each period. For live services, the sum of the start attribute of the period and the MPD attribute availableStartTime may specify the availability time of the period in UTC format, in particular the first Media Segment of each representation in the corresponding period. For on-demand services, the start attribute of the first period may be 0. For any other period, the start attribute may specify a time offset between the start time of the corresponding Period relative to the start time of the first Period. Each period may extend until the start of the next Period, or until the end of the media presentation in the case of the last period. Period start times may be precise. They may reflect the actual timing resulting from playing the media of all prior periods.

Each period may contain one or more representations for the same media content. A representation may be one of a number of alternative encoded versions of audio or video data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

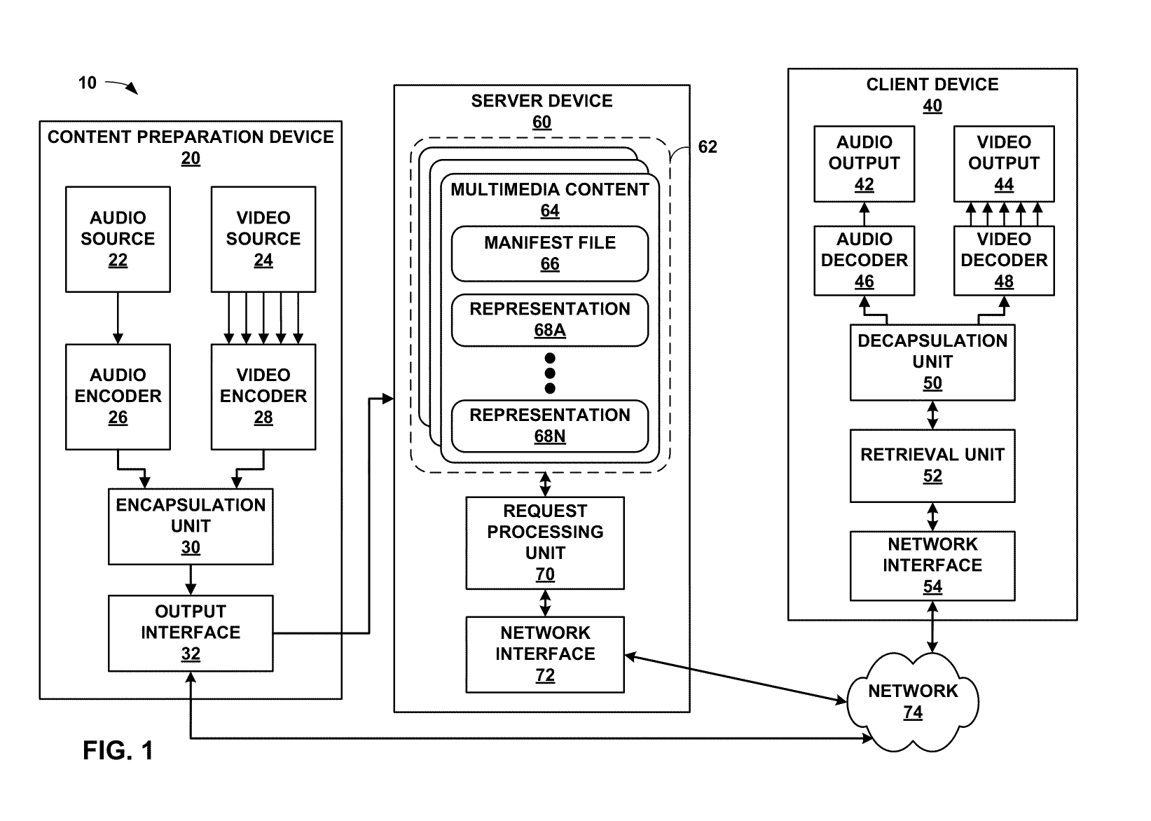

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and/or with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. In addition, encapsulation unit 30 may form a manifest file, such as a media presentation descriptor (MPD), that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. Server device 60 may act as a BM-SC, in some examples. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as enhanced multimedia broadcast multicast service (eMBMS). Content preparation device 20 may create dynamic adaptive streaming over HTTP (DASH) segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

Furthermore, in accordance with the techniques of this disclosure, request processing unit 70 of server device 60 may transmit certain relatively important data structures multiple times to client devices, such as client device 40. For example, request processing unit 70 may transmit a file delivery table (FDT) multiple times for a segment of a broadcast or multicast. In this manner, if a client device, such as client device 40, tunes in to the broadcast/multicast during the segment but after an ordinal first FDT of the segment, client device 40 may still receive a subsequent FDT for the segment and use the FDT to extract at least some usable data of the segment.

Request processing unit 70 of server device 60 may transmit the FDT multiple times for a current segment in various ways. For instance, request processing unit 70 may transmit the FDT as part of an ordinal-first multicast channel (MCH) scheduling period (MSP) for the current segment and as part of an ordinal last MSP for the current segment. Alternatively, request processing unit 70 may transmit the FDT in each MSP for the current segment. As yet another example, request processing unit 70 may transmit the FDT in alternating MSPs (i.e., every other MSP) for the current segment. Thus, client device 40 may receive an FDT for a current segment that is not included in an ordinal-first MSP for the current segment, such that the FDT that client device 40 receives for the current segment is included in an MSP other than the ordinal-first MSP for the current segment. Likewise, client device 40 may be able to extract data of the current segment without receiving the ordinal-first MSP for the current segment.

As another example, which may be in addition or in the alternative to the example discussed above, request processing unit 70 of server device 60 may send repeated encoding symbols for the current segment. In general, the encoding symbols represent data of the segment, such as movie fragments of the segment. Server device 60 may determine that certain movie fragments, such as those including an intra-coded frame (I-frame) are relatively more important than others. For example, inter-coded frames (such as P-frames and B-frames) are generally predicted from other frames, such as an I-frame. Thus, if the I-frame is not correctly received, inter-coded frames may not be decodable, even if data of the inter-coded frames is correctly received. Therefore, server device 60 may send encoding symbols representative of the I-frame repeatedly, to increase the probability that the I-frame is correctly received by client devices that are tuned into the broadcast/multicast. I-frames may also be treated as key frames. Some other frames may also be treated as key frames, such as certain P-frames. In general, key frames correspond to frames that serve as the basis for predicting subsequent frames in a sequence of frames, e.g., a group of pictures (GOP).

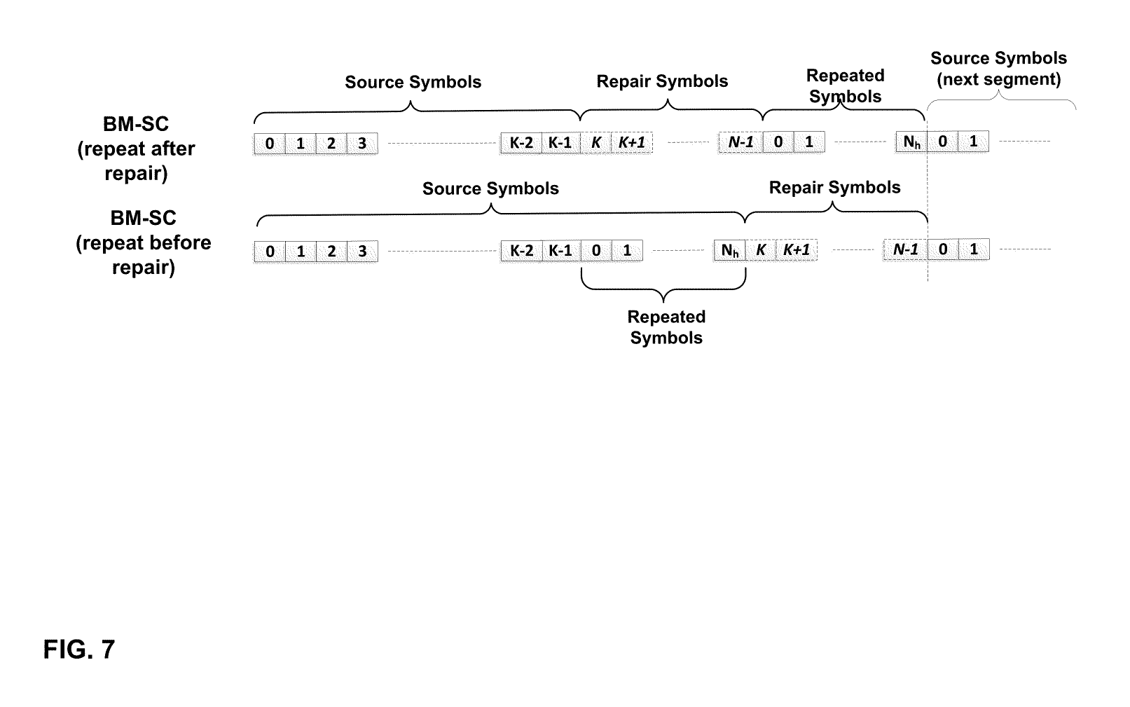

In some examples, request processing unit 70 of server device 60 may send the repeated encoding symbols after a set of repair symbols for a first set of encoding symbols for the current segment. In another example, server device 60 may send the repeated encoding symbols before the repair symbols. Examples of repeated encoding symbols are discussed in greater detail below with respect to FIG. 7.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium 34, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Although not shown explicitly in the example of FIG. 1, client device 40 may further include a media application (which may also be referred to as a streaming client or media player). The media application may perform all or a portion of the functionality of any of audio decoder 46, video decoder 48, decapsulation unit 50, and/or retrieval unit 52. For example, the media application may form part of retrieval unit 52, or be separate from retrieval unit 52. In addition to the functionality described above, the media application may cause client device 40 to present a user interface, such as a graphical user interface (GUI) to a user to allow for selection of multimedia data, such as a movie or other program content. The media application may provide an indication of the selected content to retrieval unit 52 to cause retrieval unit 52 to receive media data of the selected program content, as discussed above. The media application may be stand-alone software, a combination of hardware and software, or a hardware unit or multiple hardware units. When implemented in software, requisite hardware (such as a processor and memory for storing instructions to be executed by the processor) may also be provided.

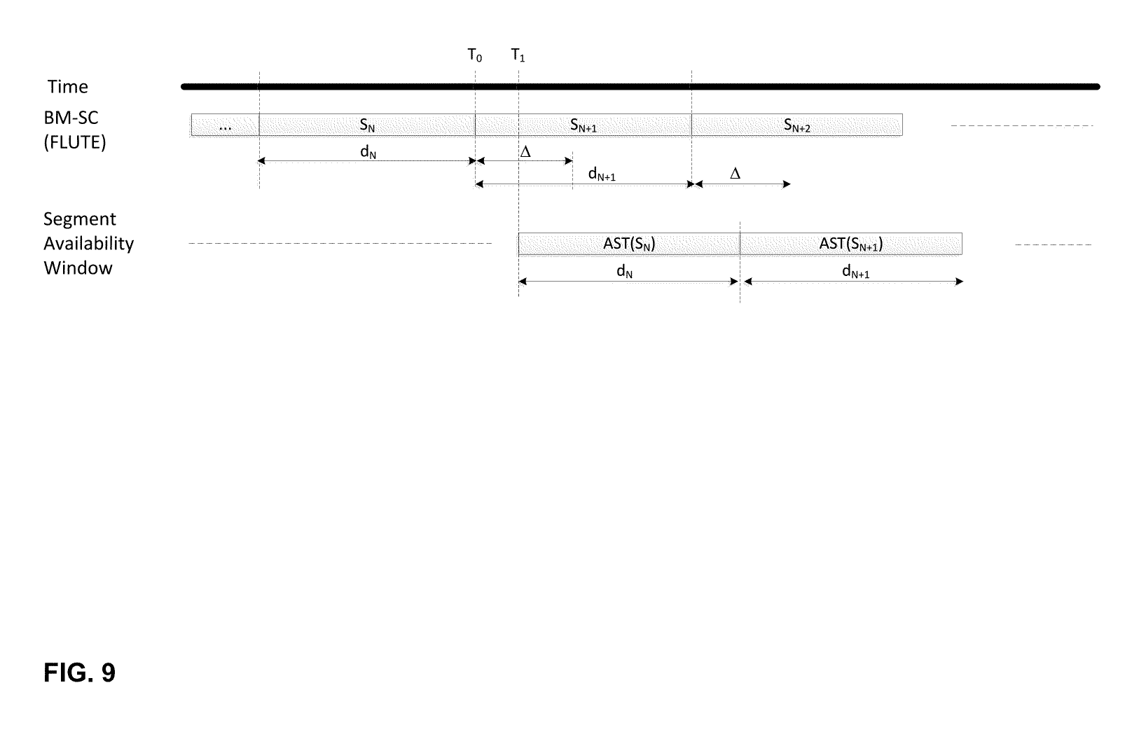

Furthermore, in accordance with the techniques of this disclosure, retrieval unit 52 may provide partially received DASH segments to decapsulation unit 50 and/or the media application. Examples of these techniques are described in detail below with respect to FIGS. 9-12.

In general, retrieval unit 52 may be configured to determine that a remaining portion of a partially received DASH segment will not be received, e.g., prior to a scheduled time for an end of delivery. That is, a file delivery table (FDT) or other transmission data may indicate a time at which transmission of data for a segment will end. However, this time is typically much later than an actual time at which transmission of data for the segment ends. Thus, rather than relying on the FDT, retrieval unit 52 may be configured to determine when remaining data for a current, partially received segment will not be received.

Retrieval unit 52 may use one or more various techniques to determine when remaining data of a partially received segment will not be received. For example, if retrieval unit 52 receives a transport object identifier (TOI) for a subsequent segment (that is, a segment following a partially received segment), retrieval unit 52 may determine that no further data for the partially received segment will be received. As another example, retrieval unit 52 may determine that no further data will be received in response to receiving a request for data of the partially received segment from a media application (not shown). Thus, it should be understood that the determination that further data for the partially received segment does not necessarily mean that, in fact, no further data will be received.

As yet another example, retrieval unit 52 may be configured to calculate an estimated time for an end of transmission for data of a current segment, e.g., based on a transmission rate of data for the segment (or data of a representation including the segment). Then, once the current time reaches or exceeds the estimated time, retrieval unit 52 may determine that no further data for the current segment will be received. Alternatively, retrieval unit 52 may deliver data for the current, partially received segment prior to the estimated time in response to a request from the media player for data of the segment.

In another example, retrieval unit 52 may determine a time at which transmission of a subsequent segment (following the current, partially received segment) is to begin, as well as an offset to be applied to that time. If retrieval unit 52 receives a request from a media player for data of the current segment from the media player at or after the determined time plus the offset, retrieval unit 52 may determine that no further data for the current segment will be received.

After determining that a remaining portion of data for a current, partially received segment will not be received, retrieval unit 52 may deliver the partially received segment, e.g., to a media application (also referred to as a streaming application), such as a DASH client. As discussed above, the determination that the remaining portion of the partially received segment will not be received may correspond to a determination that the remaining portion will not be received in time for delivery to the media application. Thus, retrieval unit 52 may in fact receive additional data for the partially received segment at a later time, i.e., after the partially received segment has been delivered to the media application. When the media application receives a partial segment, the media application may attempt to play (i.e., present) the partial segment. In this manner, at least some data of the partial segment may be presented, which may provide a better user experience that completely discarding the partial segment.

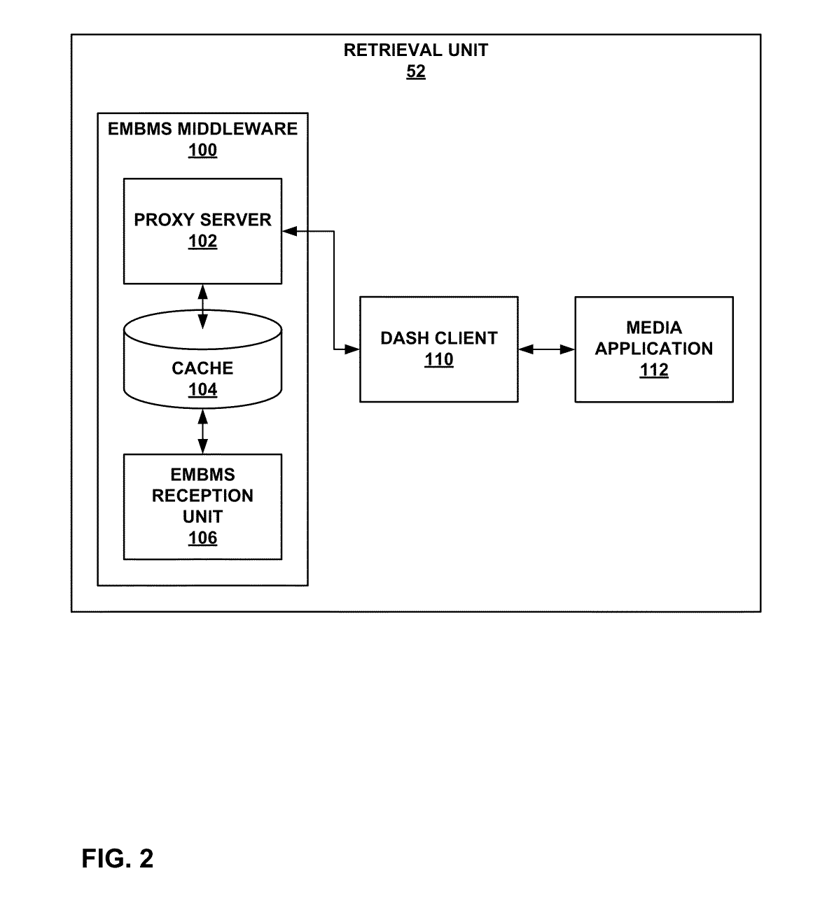

FIG. 2 is a block diagram illustrating an example set of components of retrieval unit 52 of FIG. 1 in greater detail. In this example, retrieval unit 52 includes eMBMS middleware unit 100, DASH client 110, and media application 112.

In this example, eMBMS middleware unit 100 further includes eMBMS reception unit 106, cache 104, and proxy server 102. In this example, eMBMS reception unit 106 is configured to receive data via eMBMS, e.g., according to File Delivery over Unidirectional Transport (FLUTE), described in T. Paila et al., “FLUTE—File Delivery over Unidirectional Transport,” Network Working Group, RFC 6726, November 2012, available at http://tools.ietf.org/html/rfc6726. That is, eMBMS reception unit 106 may receive files via broadcast from, e.g., server device 60, which may act as a BM-SC.

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Proxy server 102 may act as a proxy server for DASH client 110. For example, proxy server 102 may provide a MPD file or other manifest file to DASH client 110. Proxy server 102 may advertise availability times for segments in the MPD file, as well as hyperlinks from which the segments can be retrieved. These hyperlinks may include a localhost address prefix corresponding to client device 40 (e.g., 127.0.0.1 for IPv4). In this manner, DASH client 110 may request segments from proxy server 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server 102. Proxy server 102 may retrieve requested data from cache 104 and provide the data to DASH client 110 in response to such requests.

In accordance with the techniques of this disclosure, eMBMS middleware unit 100 may be configured to provide partially received segments to DASH client 110. That is, the functionality attributed to retrieval unit 52 regarding determining that a remaining portion of a current, partially received segment will not be received (e.g., before delivery of the segment to DASH client 110) may be performed by eMBMS middleware unit 100. For example, eMBMS middleware unit 100 may determine that the remaining portion will not be received based on any or all of reception of a TOI for a subsequent segment, receiving a request for the current segment from DASH client 110, calculating an estimated time for an end of transmission of the current segment, and/or an offset applied to a time at which a subsequent segment is to begin transmission, or the like.

After receiving data of a segment, DASH client 110 may pass data of the segment to media application 112, whether the segment is fully or partially received. DASH client 110 may process the segment, e.g., to extract media data from the segment and/or to discard data that is unusable by media application 112.

As discussed above with respect to FIG. 1, FDTs for a segment may be transmitted multiple times. Thus, if retrieval unit 52 receives data of a segment currently being transmitted but does not receive an ordinal first FDT, retrieval unit 52 may nevertheless receive a subsequent FDT for the current segment. In such cases, eMBMS middleware unit 100 may use the FDT to extract usable data of the current segment and send such data to DASH client 110. In this manner, DASH client 110 may utilize data of a partially received segment, rather than discarding the segment because not all of the data for the segment has been received. In general, the FDT describes byte locations of data in the FDT, such as indications of key frames, movie fragments, or the like in the segment. If multiple FDTs for the segment are received, eMBMS middleware unit 100 may discard duplicate FDTs for the segment.

In this manner, eMBMS middleware unit 100 represents an example of a middleware unit of a client device (which also includes a streaming client), where the middleware unit is configured to receive a first portion of data of a current segment of media data, wherein file delivery information for the current segment indicates that transmission of the data for the current segment will end at a first time, determine, prior to the first time, that a remaining portion of the data of the current segment will not be received, and, based on the determination, deliver at least some of the first portion of data to the streaming client.

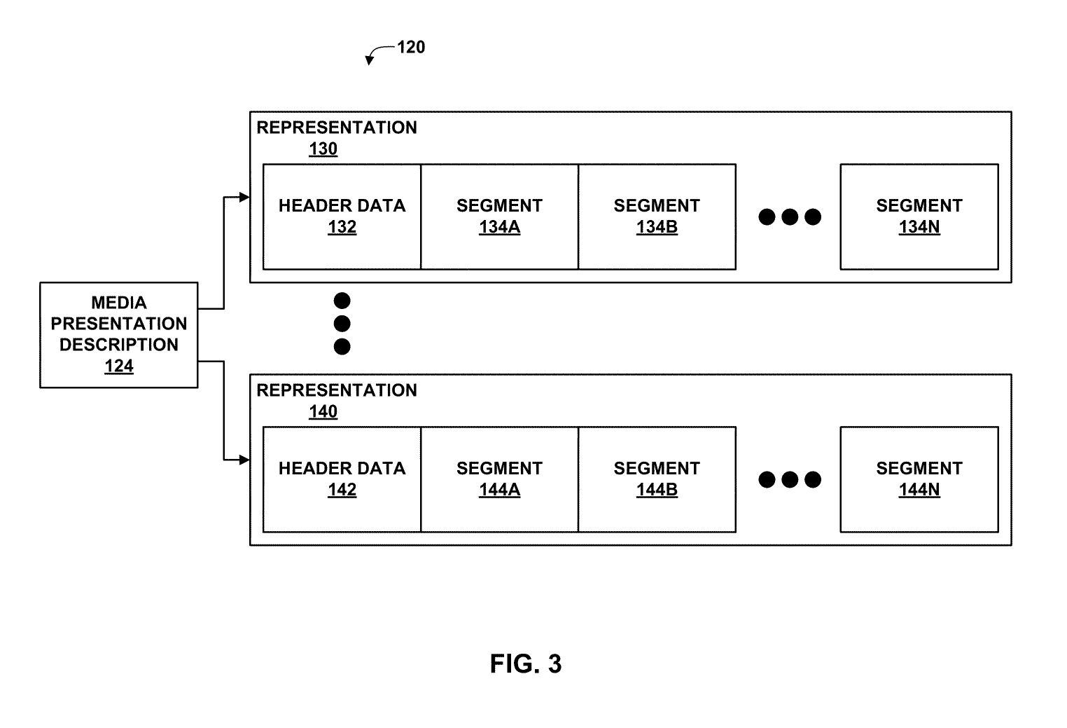

FIG. 3 is a conceptual diagram illustrating elements of example multimedia content 120. Multimedia content 120 may correspond to multimedia content 64 (FIG. 1), or another multimedia content stored in storage medium 62. In the example of FIG. 3, multimedia content 120 includes media presentation description (MPD) 124 and a plurality of representations 130-140. Representation 130 includes optional header data 132 and segments 134A-134N (segments 134), while representation 140 includes optional header data 142 and segments 144A-144N (segments 144). The letter N is used to designate the last movie fragment in each of representations 130, 140 as a matter of convenience. In some examples, there may be different numbers of movie fragments between representations 130, 140.

MPD 124 may comprise a data structure separate from representations 130-140. MPD 124 may correspond to manifest file 66 of FIG. 1. Likewise, representations 130-140 may correspond to representations 68 of FIG. 1. In general, MPD 124 may include data that generally describes characteristics of representations 130-140, such as coding and rendering characteristics, adaptation sets, a profile to which MPD 124 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 132, when present, may describe characteristics of segments 134, e.g., temporal locations of random access points (RAPS, also referred to as stream access points (SAPs)), which of segments 134 includes random access points, byte offsets to random access points within segments 134, uniform resource locators (URLs) of segments 134, or other aspects of segments 134. Header data 142, when present, may describe similar characteristics for segments 144. Additionally or alternatively, such characteristics may be fully included within MPD 124.

Segments 134, 144 include one or more coded video samples, each of which may include frames or slices of video data. Each of the coded video samples of segments 134 may have similar characteristics, e.g., height, width, and bandwidth requirements. Such characteristics may be described by data of MPD 124, though such data is not illustrated in the example of FIG. 3. MPD 124 may include characteristics as described by the 3GPP Specification, with the addition of any or all of the signaled information described in this disclosure.

Each of segments 134, 144 may be associated with a unique uniform resource locator (URL). Thus, each of segments 134, 144 may be independently retrievable using a streaming network protocol, such as DASH. In this manner, a destination device, such as client device 40, may use an HTTP GET request to retrieve segments 134 or 144. In some examples, client device 40 may use HTTP partial GET requests to retrieve specific byte ranges of segments 134 or 144.

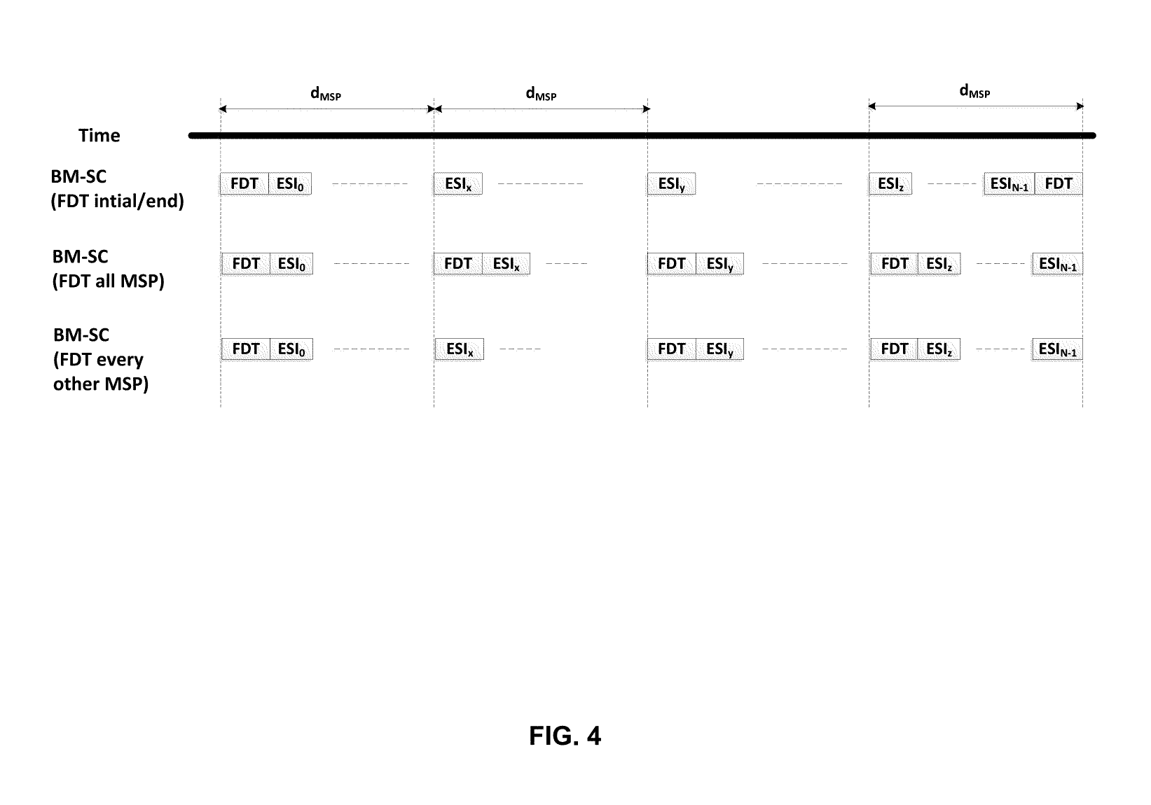

FIG. 4 is a conceptual diagram illustrating an example technique in which a BM-SC, such as server device 60 of FIG. 1, sends a file delivery table (FDT) relatively frequently. The FDT includes information indicative of a filename, content length, and FDT expiry for a file delivered according to, e.g., FLUTE. If eMBMS middleware unit 100 does not receive the FDT, eMBMS middleware unit 100 will likely not be able to create the file from received data, due to not having the filename, content length, and FDT expiry information.

Accordingly, the examples of FIG. 4 represent techniques in which the FDT is retransmitted frequently. In particular, FIG. 4 portrays three examples. FIG. 4 illustrates various multicast channel (MCH) scheduling periods (MSPs), each having a particular duration (d_{MSP}). In the first example of FIG. 4, an FDT is transmitted in both the first MSP and the last MSP. In the second example of FIG. 4, an FDT is sent in every MSP. In the third example of FIG. 4, the FDT is sent in every other MSP. By providing the FDT multiple times, the likelihood that the FDT will arrive at the client device is increased. Also during each MSP, one or more encoding symbols having respective particular encoding symbol identifiers (ESIs) are transmitted.

The overhead for retransmitting the FDT is relatively low in each of these examples. Assume that the FDT is sent in every MSP, a segment bitrate is 1.5 Mbps, and FDT_size=1 Kbyte. For a d_{MSP} of 160 msec (where data in each MSP is approximately 30 Kbyte), the overhead for signaling FDTs is approximately 3%. If the segment duration is 2 seconds, 12 FDTs are sent. For a d_{MSP} of 320 msec (where data in each MSP is approximately 60 Kbyte), the overhead for signaling FDTs is approximately 1.5%. If the segment duration is 2 seconds, 6 FDTs are sent. As shown in the third example of FIG. 4, sending the FDT in every other MSP may further reduce the signaling overhead while still providing the FDT multiple times.

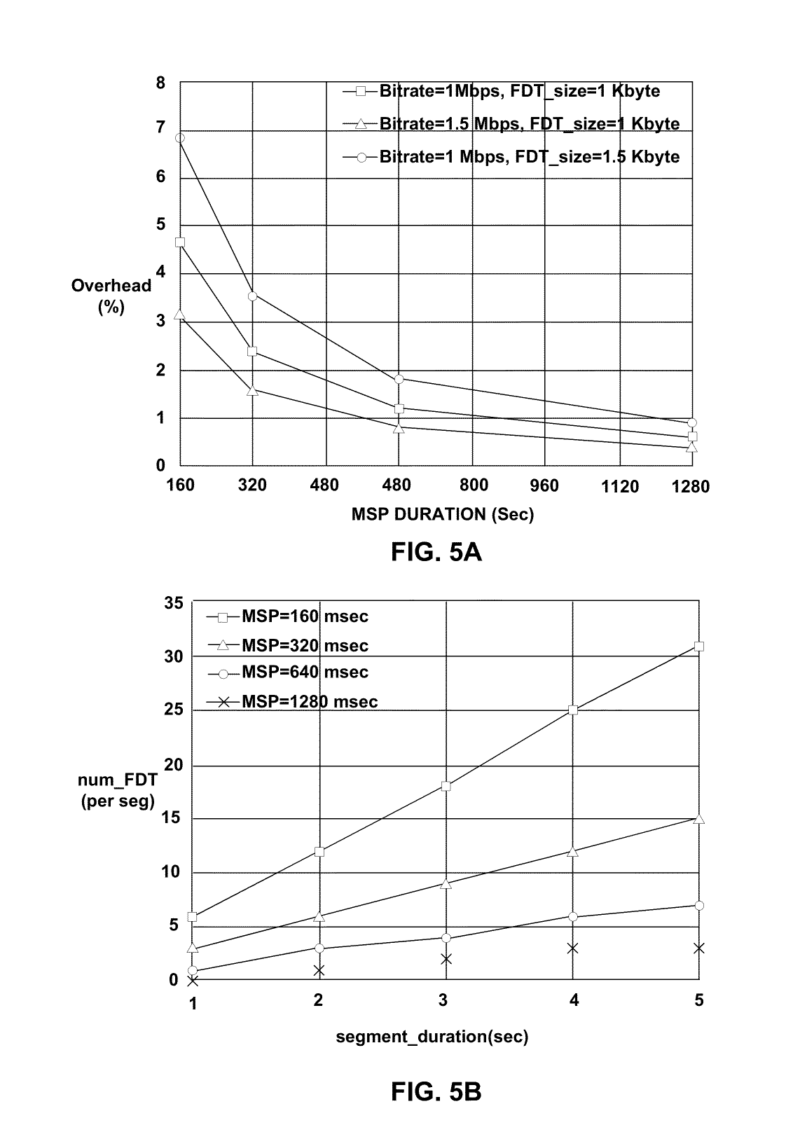

FIGS. 5A and 5B are graphs representing analyses of overhead associated with sending an FDT multiple times. Four scenarios are represented in the analysis of FIG. 5A, which represents an MSP duration in milliseconds (msec) along the x-axis and an overhead in percent along the y-axis:
Square-shaped nodes represent a scenario where the bitrate is 1 Mbps and FDT_size is 1 Kbyte
Triangular nodes represent a scenario where the bitrate is 1.5 Mbps and FDT_size is 1 Kbyte
Circular nodes represent a scenario where the bitrate is 1 Mbps and FDT_size is 1.5 Kbyte

Furthermore, in FIG. 5B, the number of file delivery tables sent per segment is shown relative to the segment duration, for various MSP durations (d_{MSP}). In FIG. 5B, which represents segment duration in seconds along the x-axis and a number of FDTs along the y-axis:
Square-shaped nodes represent a d_{MSP} of 160 msec
Triangular nodes represent a d_{MSP} of 320 msec
Circular nodes represent a d_{MSP} of 640 msec
X-shaped nodes represent a d_{MSP} of 1280 msec

The overhead for sending an FDT in every MSP can be calculated by:

O(A)=FDT_size/(data_size_msp+FDT_size) (1)

The overhead for sending an FDT in every other MSP can be calculated by:

$$\begin{matrix}O ( B ) = FDT\_size / ( {2}^{*} data\_size \_msp + FDT\_size ) ( 2 ) \\ \approx {0.5}^{*} O ( A ) ) ( 3 )\end{matrix}$$

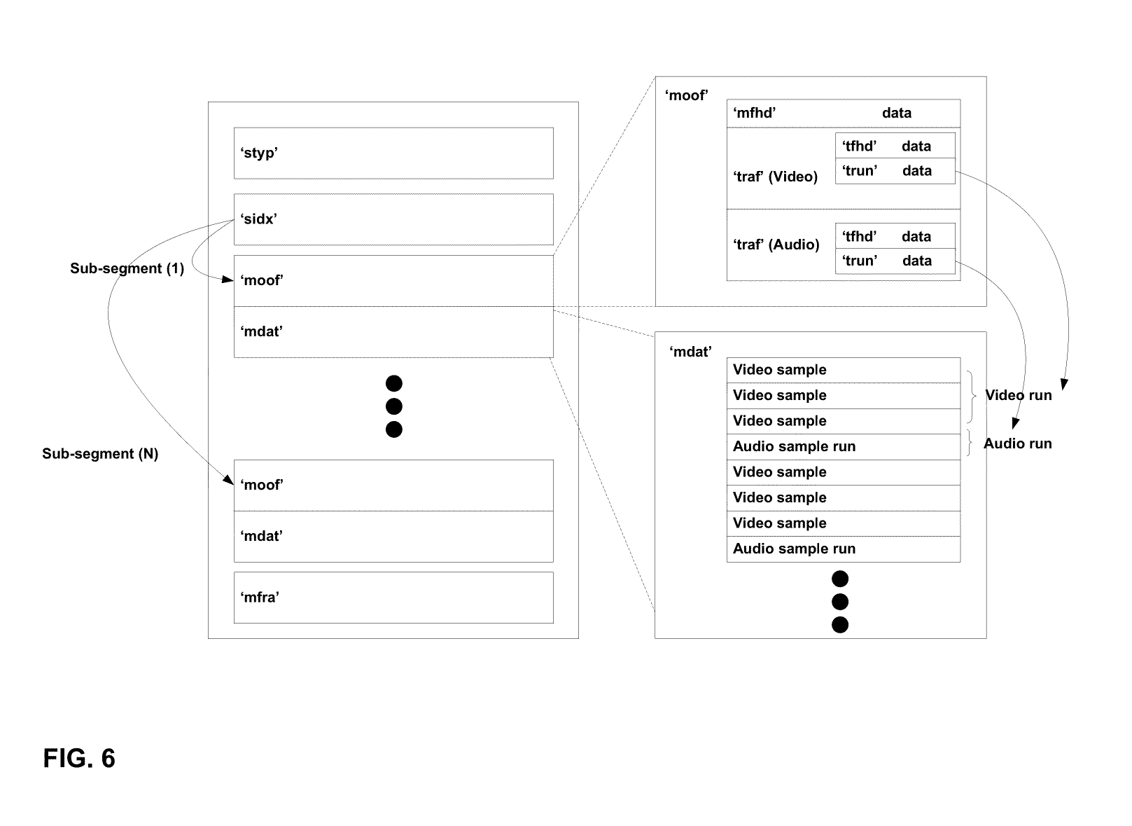

FIG. 6 is a block diagram illustrating example contents of a segment. As explained above, segments may include various “boxes,” e.g., styp, sidx, moof, mdat, mfra, and the like, as shown in FIG. 6. In order to perform partial DASH segment delivery, certain boxes are more important than others. For example, if a sidx box (which is typically present in the first few bytes of a segment) is missing, an MP4 decoder may not be able to locate various moof sub-segment boxes. Without the ability to locate moof boxes, the MP4 decoder may not be able to play any part of the segment. That is, a media decoder may use trun boxes, included in moof boxes, to locate sample positions. Thus, without the moof boxes, the trun boxes could not be located, and hence, sample positions could not be identified.

FIG. 7 is a conceptual diagram illustrating examples in which the BM-SC repeats the first few ESI(s) of an MSP. The first few bytes of typical DASH segments may include data sizes as discussed below. For video segments of, e.g., 5 seconds of playback at 30 fps, typical sidx and moof boxes are 1 Kbyte to 2 Kbytes, and include approximately 150 samples (5*30). For audio segments of, e.g., 5 seconds and 48 KHz, typical sidx and moof boxes are 1 Kbyte to 4 Kbytes, and include approximately 240 samples (5*48). In high error scenarios, received portions of a segment might be too small. For example, received portions might be smaller than a typical video frame or audio sample. For video segments of 1 Mbps and 30 fps, the average frame size is approximately 4.26 Kbytes. For audio segments of 40 kbps and 48 KHz, the average audio sample is 107 bytes.

To provide protection against such sensitive data, the BM-SC (e.g., server device 60 of FIG. 1) may send the first Nₕ ESIs (ESIᵢ for i=(0, 1, . . . , Nₕ) more often. In one example, Nₕ can be estimated based on average moof box size received from DASH encoder. For example, Nₕ may be determined as:

Nₕ=(average “moof” box size+deviation factor)/(encoding symbol size, rounded to next integer) (4)

In another example, the BM-SC may perform simple deep packet inspection (DPI) for each media segment and read the 4 bytes before the moof marker in ISO-BMFF, which may identify the actual box size:

Nₕ=(actual “moof” box size)/(encoding symbol size, rounded to next integer) (5)

FIG. 7 illustrates two examples for re-sending the Nₕ symbols. Assuming that there are K source symbols and (N−K) repair symbols, in a first example shown in FIG. 7, the Nₕ symbols are sent after repair symbols. In a second example shown in FIG. 7, the Nₕ symbols are sent before the repair symbols. The repair symbols are identified in FIG. 7 using italicized text and dashed outlines.

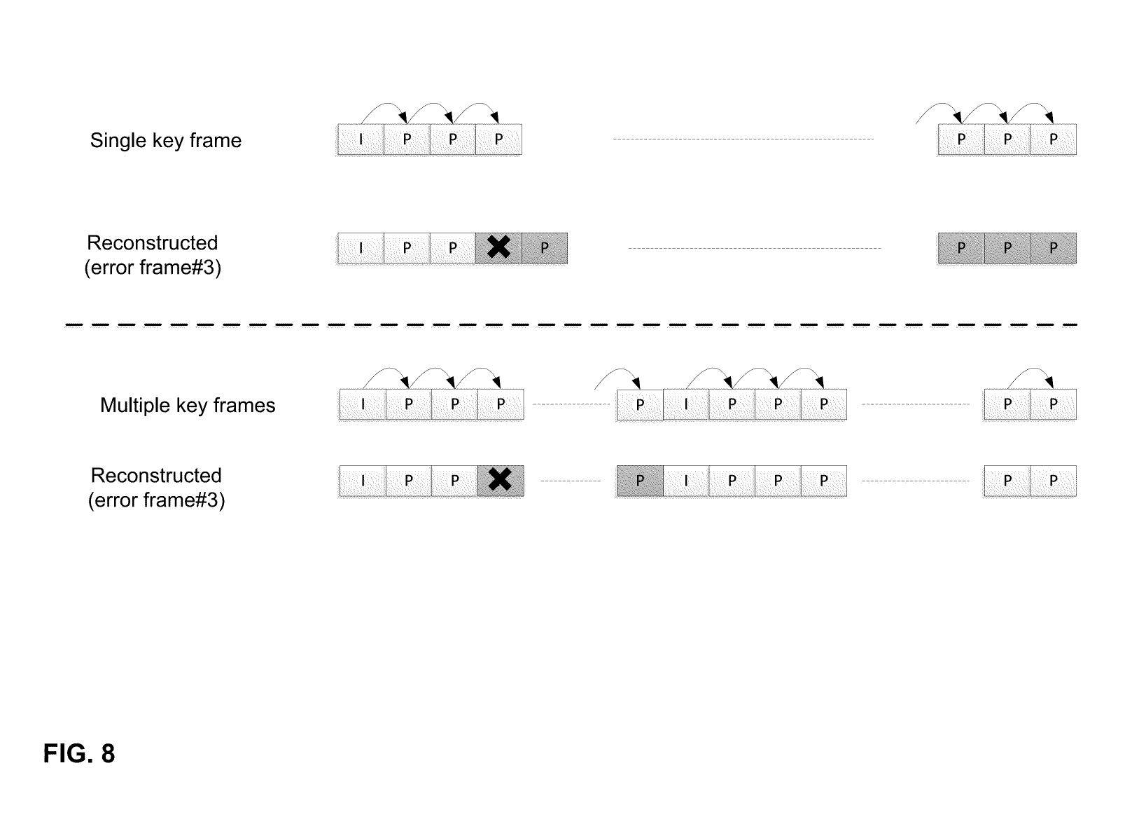

FIG. 8 is a conceptual diagram illustrating examples in which the BM-SC repeats sending of key frames. A key frame generally corresponds to a frame that is needed for proper decoding of subsequent frames. Key frames may include intra-predicted frames (I-frames). Key frames may also act as intra random access points (IRAPs).

Video coding uses predictive coding techniques to achieve target bit rates. That is, inter-predicted frames, such as P-frames (uni-directionally predicted frames) and B-frames (bi-directionally predicted frames) are predicted from either predicted frames or other frames that were, ultimately, predicted from key frames. For example, as shown in FIG. 8, when two frames are coupled by an arrow, the base of the arrow indicates a reference frame and the head of the arrow represents a frame that may be predicted from the reference frame.

In this manner, key frames may be used for random access, while other frames (P-frames and B-frames) may be encoded subsequently, with reference to the key frame(s). Due to predictive coding, errors in a single inter-predicted frame may continue to be visible in subsequent frames until a next key frame is received. Missing the reception of a key frame may make a whole segment useless, from a video decoding perspective. Thus, in accordance with the techniques of this disclosure, the BM-SC may perform a DPI process to identify key frames from, e.g., the trun box of a segment, to identify the location and size of a key frame. Afterward, the BM-SC may repeat transmission of the key frames, e.g., at the end of transmission.

FIG. 9 is a conceptual diagram illustrating an example technique by which eMBMS middleware unit 100 may detect an incomplete segment reception using a transport object identifier (TOI). In accordance with FLUTE, an FDT includes FDT expiration information, which is generally set to a few seconds after the end of transmission (T₀+Δ). At any time before T₀+Δ, once eMBMS middleware unit 100 receives enough encoding symbols for segment S_{N}, eMBMS middleware unit 100 may perform FEC decoding of segment S_{N}.

Typically, transmission of a subsequent segment (S_{N+1}) starts at T₀. The segment availability window for segment S_{N} starts at T₁, after adjusting for BM-SC transmission delay (T₁<T₀+Δ). Based on the FDT expiry for S_{N} (that is, time T₀+Δ), eMBMS middleware unit 100 would send HTTP 404 error responses to DASH client 110 for any requests for segment S_{N} made before time T₀+Δ, assuming Δ is less than the segment duration (as shown in the example of FIG. 9).

However, in accordance with one example of the techniques of this disclosure, after receiving a new TOI for segment S_{N+1} (shortly after T₀), eMBMS middleware unit 100 may determine that transmission of data for the previously transmitted segment (S_{N}) has ended. This example assumes that there are non-overlapping transmissions of a non-multiplexed representation. Accordingly, rather than sending HTTP 404 error responses for any requests made prior to time T₀+Δ, eMBMS middleware unit 100 may send received data of segment S_{N} (that is, HTTP 206 responses) in response to requests from DASH client 110 for the data of segment S_{N} after eMBMS middleware unit 100 receives a TOI of a subsequent segment (e.g., segment S_{N+1}). In this example, Δ may be longer than the segment duration.

In this manner, the techniques of FIG. 9 represent an example of a method of sending media data from a middleware unit of a client device to a streaming client of the client device, the method comprising, by the middleware unit, receiving data of a current segment of media data, wherein file delivery information for the current segment indicates that transmission of the data for the current segment will end at a first time, after receiving the data of the current segment, receiving a transport object identifier (TOI) of a subsequent segment before the first time, and sending at least some of the received data of the current segment to the streaming client in response to requests for the data of the current segment from the streaming client when the requests are received after receiving the TOI of the subsequent segment and before the first time.

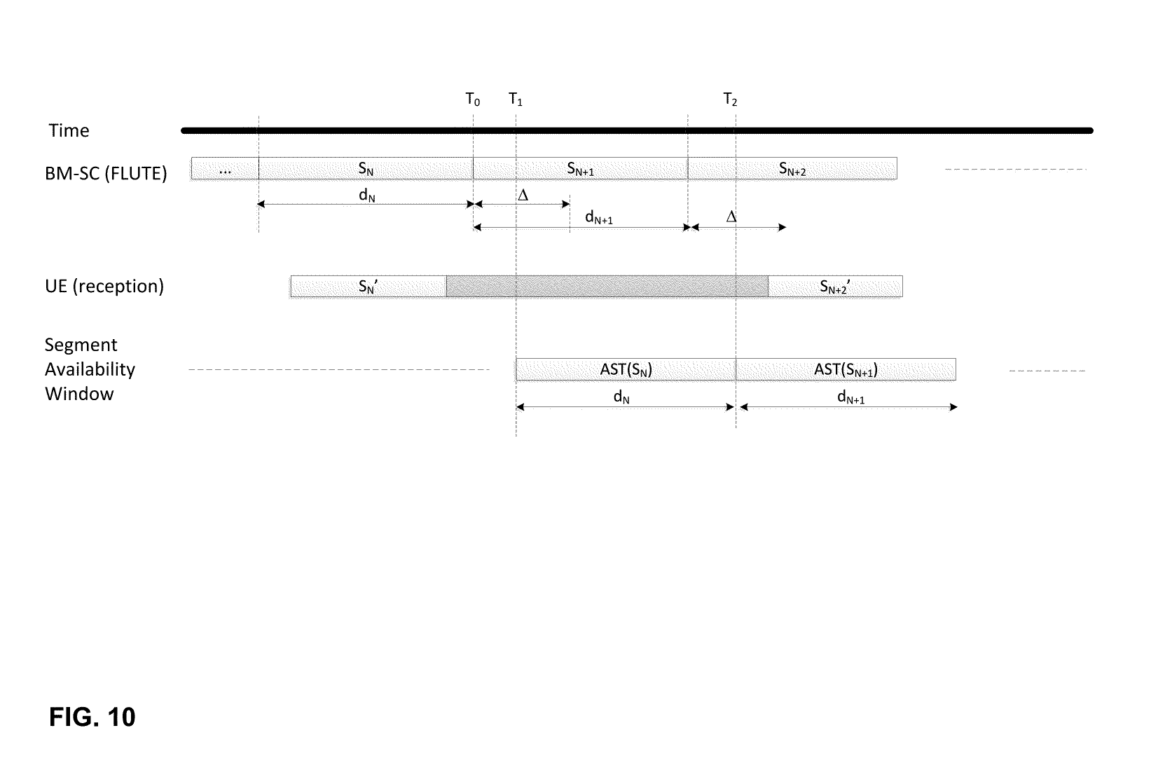

FIG. 10 is a conceptual diagram illustrating an example technique by which eMBMS middleware unit 100 may detect incomplete segment reception. This example technique may be performed alone or in combination with the example technique of FIG. 9. In FIG. 10, “UE” represents user equipment, e.g., client device 40 (FIG. 1).

In this example, it is assumed that prior to time T₀, reception conditions for eMBMS middleware unit 100 to receive data of segment S_{N} become relatively poor. The grey shaded region of FIG. 10 represents data received during the time of poor reception, which causes errors in the received data in this example. eMBMS middleware unit 100 may not receive the TOI for segment S_{N+1}, e.g., due to the poor reception conditions. At time T₀+Δ(that is, FDT expiry), eMBMS middleware unit 100 can identify incomplete reception of S_{N} and provide partial data of segment S_{N} to DASH client 110 (late decision).

Additionally or alternatively, eMBMS middleware unit 100 may detect an incomplete segment using an HTTP GET request received from DASH client 110. For example, if eMBMS middleware unit 100 receives an HTTP GET request for segment S_{N} from DASH client 110 at or after time T₁, eMBMS middleware unit 100 may determine that transmission for segment S_{N} has finished (in response to the HTTP GET request) and provide received data of segment S_{N} to DASH client 110.

In the example of FIG. 10, at a time later than T₂, DASH client 110 sends a request for segment S_{N+1}. However, as noted above, it is assumed in the example of FIG. 10 that eMBMS middleware unit 100 does not receive an FDT for segment S_{N+1}. As a result of not receiving the FDT for segment S_{N+1}, eMBMS middleware unit 100 may simply send an HTTP 404 error response to DASH client 110, because without the FDT, eMBMS middleware unit 100 may be unable to reconstruct segment S_{N+1}.

In this manner, the techniques of FIG. 10 represent an example of a method of sending media data from a middleware unit of a client device to a streaming client of the client device, the method comprising, by the middleware unit, receiving data of a current segment of media data, wherein file delivery information for the current segment indicates that transmission of the data for the current segment will end at a first time, receiving one or more requests for the data of the current segment of the media data before the first time, and in response to the one or more requests, sending at least some of the received data of the current segment to the streaming client.

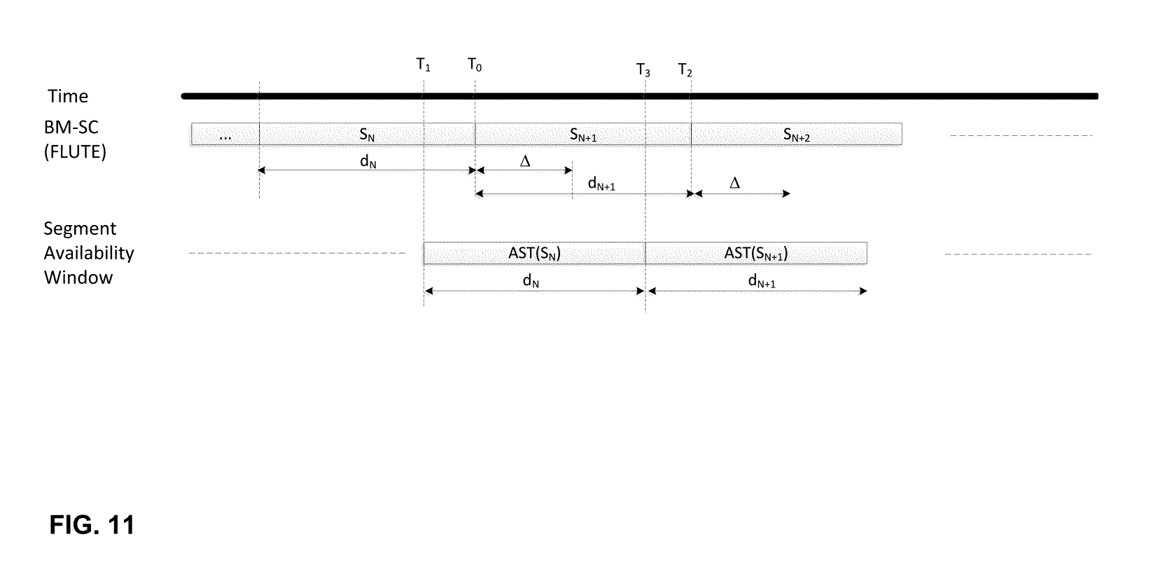

FIG. 11 is a conceptual diagram illustrating an example technique by which eMBMS middleware unit 100 may detect an incomplete segment reception using a processing margin. This technique may be used alone or in any combination with the techniques of FIGS. 9 and/or 10. This issue may happen when the BM-SC introduces extra delay after eMBMS middleware unit 100 adjusts an availability start time (AST) using an initial, smaller delay.

As shown in FIG. 11, at time T₁, DASH client 110 sends an HTTP GET request for segment S_{N}. Based on the BM-SC transmission schema within the MSP, segment S_{N} is not ready, and is expected to be completed at time T₀, which is later than T₁. eMBMS middleware unit 100 may estimate T₀′ according to the following formula:

$${T}_{0}^{′} \approx {T}_{FDT} + ⌊ \frac{seg\_dur}{MSP} ⌋ * MSP \qquad ( 6 )$$

where T_{FDT} is the time of receiving the first FDT of the segment or the first packet for a new TOI that includes ESIi for the segment, and seg_dur represents segment duration. This formula can be simplified further as:

T₀′≈T_{FDT}+seg_dur (7)

to remove dependency on MSP that might not be known to some eMBMS middleware implimintation.

eMBMS middleware unit 100 may be configured based on the assumption that no more ESIs are sent if the FDT expires or T₀′ has passed. If DASH client 110 sends HTTP GET requests for segment S_{N} between times T₁ and T₀, eMBMS middleware unit 100 may respond with HTTP 404 error messages, but to deliver data of segment S_{N} to DASH client 110 for requests received following the FDT expiry or after time T₀′. This technique may allow an incomplete segment to be independently decided at the FLUTE reception module, e.g., eMBMS middleware unit 100. In some examples, the BM-SC may signal time T₀′ in the FDT as an optional duration parameter with a suitable time granularity.

Furthermore, eMBMS middleware unit 100 may delay responses to HTTP GET requests. An issue may arise when the BM-SC introduces extra delay and eMBMS middleware unit 100 has adjusted the AST in the MPD with a certain value (assuming minimal delay from the BM-SC). This example technique is also explained with respect to FIG. 11.

At time T₁ in this example, DASH client 110 sends an HTTP GET request for segment S_{N}. Based on a FLUTE rate of transmission, segment S_{N} is not yet ready, but is expected to be completed at time T₀, which is after time T₁. eMBMS middleware unit 100 may estimate the rate of transmission heuristically using encoding symbol identifier (ESI) arrival timing.

When detecting such an event for the first time, eMBMS middleware unit 100 has the following options:

1) Early delay: eMBMS middleware unit 100 can delay the HTTP response for additional time α, where α may be equal to T₀-T₁. Any subsequent HTTP GET request for the same URI need not be delayed.
2) Late delay: if the HTTP GET request is for an initial Range of bytes that are already received, eMBMS middleware unit 100 may respond (without delay) by including the requested content in an HTTP 206 response. Subsequent HTTP GET requests for un-received Ranges of bytes for the same URI may be delayed by α.

The techniques above assume that α is much less than the segment duration. Otherwise, the BM-SC may send segments too late compared to the adjusted AST. In this example, the MPD contains only one representation per media component. Otherwise, DASH client 110 may switch representations because of the longer delay in receiving a response.

For subsequent HTTP GET requests (for a new URI), eMBMS middleware unit 100 has the following options:
1) Static delay adjustment: eMBMS middleware unit 100 may delay by the estimated amount discussed above (α). One possible enhancement is for eMBMS middleware unit 100 to recalculate a new a after receiving a configurable number of HTTP GET requests N_{α}.
2) Dynamic delay adjustment: eMBMS middleware unit may estimate a new a and delay the response accordingly. Although this implementation may be complex, it can be used to quickly adapt to any adjustment to extra delay introduced by the BM-SC.

In this manner, the techniques of FIG. 11 represent an example of a method of sending media data from a middleware unit of a client device to a streaming client of the client device, the method comprising, by the middleware unit, receiving data of a current segment of media data, determining an expected time at which transmission of data for the current segment will end based on a determined rate of transmission of the media data, receiving one or more requests for the data of the current segment of the media data from the streaming client before the expected time, and waiting until after the expected time to respond to the one or more requests.

Likewise, the techniques of FIG. 11 also represent an example of a method of sending media data from a middleware unit of a client device to a streaming client of the client device, the method comprising, by the middleware unit, receiving data of a current segment of media data, determining an expected time at which transmission of data for the current segment will end based on a determined rate of transmission of the media data, receiving a request for a portion of the data of the current segment from the streaming client before the expected time, and when the requested portion has already been received, sending the requested portion to the streaming client before the expected time.

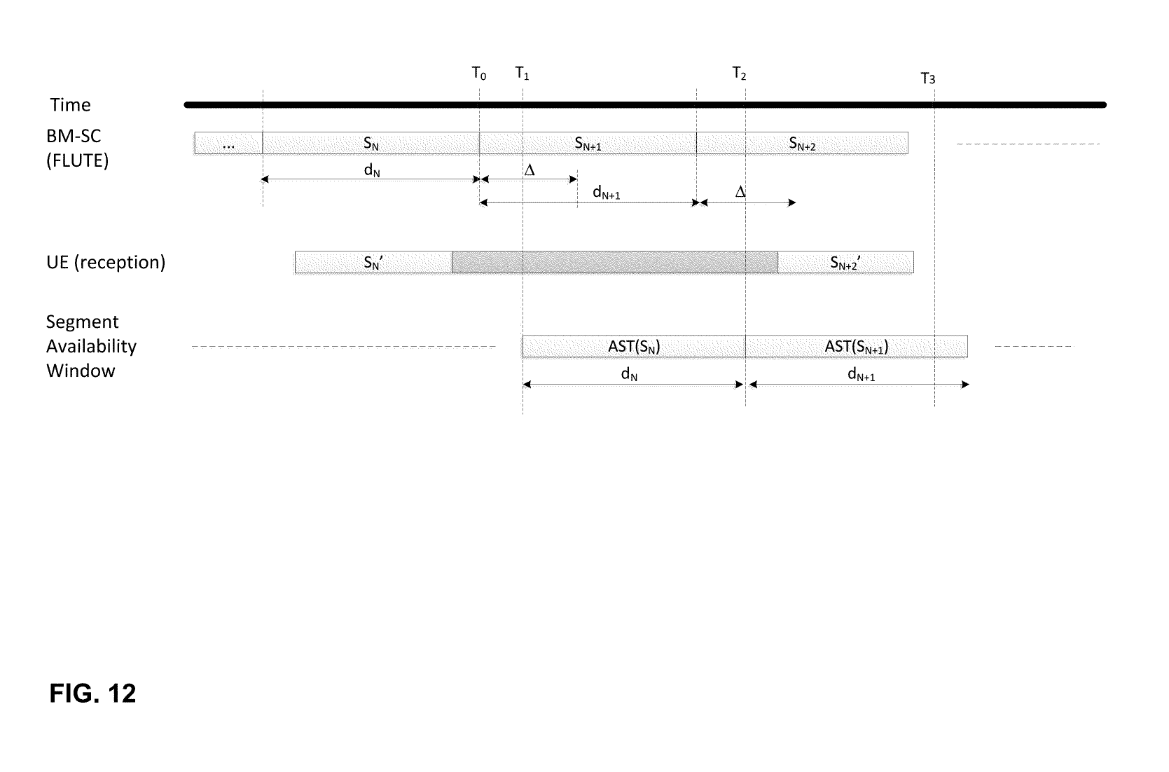

FIG. 12 is a conceptual diagram illustrating an example in which eMBMS middleware unit 100 sets a deadline to trigger partial segment recovery. This technique may be used alone or in any combination with the techniques of FIGS. 9-11. The expiry of the FDT, in this example, is set to a few seconds after the end of the transmission. FDT expiry may be set to a time T₃, beyond the end of AST of the segment transmitted at time T₂.

Once eMBMS middleware unit 100 receives enough symbols before FDT expiry, eMBMS middleware unit 100 may perform FEC decoding. If not enough data is received to start the FEC decoding, eMBMS middleware unit 100 may wait for FDT expiry, and if DASH client 110 submits HTTP GET requests between times T₁ and T₃, eMBMS middleware unit 100 may respond with HTTP 404 errors.

In accordance with this example technique of this disclosure, when 0<Δ<segment duration, if DASH client 110 sends HTTP GET requests between T₁ and T₀+Δ, eMBMS middleware unit 100 may respond to these requests with HTTP 404 errors. If DASH client 110 sends HTTP GET requests after T₀+Δ, eMBMS middleware unit 100 may respond with any segment data received (such as partial segment data if only partial segment data has been received).

In this manner, the techniques of FIG. 12 represent an example of a method of sending media data from a middleware unit of a client device to a streaming client of the client device, the method comprising, by the middleware unit, receiving data of a current segment of media data, wherein file delivery information for the current segment indicates that transmission of the data for the current segment will end at a first time, determining an offset following a time at which transmission of a subsequent segment is to begin, wherein the offset is less than a segment duration, and wherein the time at which transmission of the subsequent segment is to begin plus the offset is less than the first time, receiving one or more requests for the data of the current segment from the streaming client at or after the time at which transmission of a subsequent segment is to begin plus the offset, and in response to the one or more requests, sending at least some of the received data of the current segment to the streaming client.

Furthermore, eMBMS middleware unit 100 may be configured to provide usage analytics to, e.g., the BM-SC. For example, eMBMS middleware unit 100 may report the reception of partial segments (determined using any of the techniques described above) using an extra method between Application and Network Operators, such as “Usage Analytics.” Also, eMBMS middleware unit 100 may report partially received segments in a modem-specific logging method, such as Qualcomm Extensible Diagnostic Monitor (QxDM).

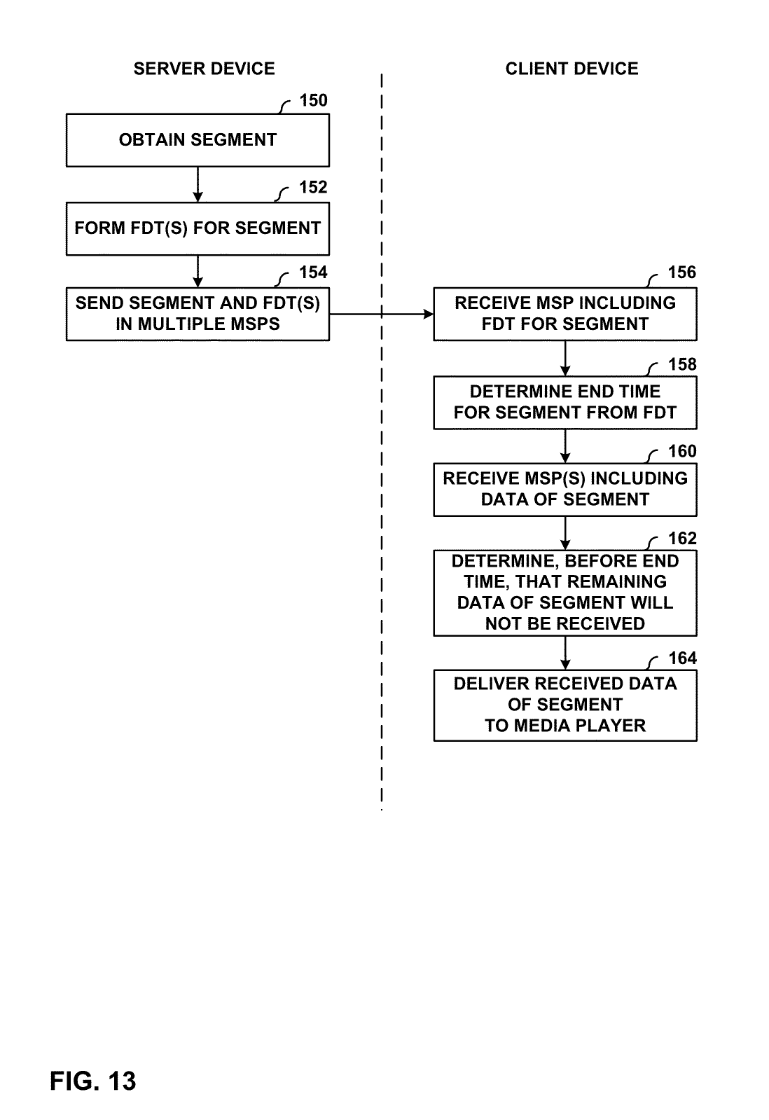

FIG. 13 is a flowchart illustrating an example method for transmitting and receiving media data in accordance with the techniques of this disclosure. The method of FIG. 13 is generally described with respect to a server device, such as server device 60 (FIG. 1) and a client device, such as client device 40 (FIG. 1). The functions attributed to client device 40 may generally be performed by, for example, an eMBMS middleware, such as eMBMS middleware unit 100 (FIG. 2).

In this example, server device 60 initially obtains a segment (150). For example, server device 60 may produce the segment or receive the segment, e.g., from content preparation device 20. As discussed above, a segment is generally an independently retrievable (and/or transmittable) file including media data, and forms part of a representation of media content. Server device 60 forms one or more file delivery tables (FDTs) for the segment (152). The FDT generally corresponds to a FLUTE FDT or similar data structure, and may indicate data for the segment, such as an identifier, content type, how the content is encoded, a hash, or the like. The FDT may further indicate an end time, that is, a time by which all data of the segment will have been sent. The techniques of this disclosure recognize, however, that data of the segment will generally be transmitted well in advance of this indicated end time.

Server device 60 sends one or more copies of the FDT for the segment, as well as data for the segment itself, in multiple multicast channel (MCH) scheduling periods (MSPs) (154). For example, server device 60 may send a single copy of the FDT or may send copies of the FDT in each MSP, alternating MSPs, an ordinal first MSP and an ordinal last MSP, or the like. Server device 60 may send this data in the form of a broadcast or multicast, e.g., in accordance with MBMS or eMBMS.

Client device 40 may receive an MSP including the FDT for the segment (156). Client device 40 may determine an end time for the segment from the FDT (158). That is, the end time as indicated in the FDT may represent a scheduled end time, such as a scheduled end time for a session for transmitting data of the segment. However, again, it is to be understood that typically, data for the segment will have finished transmitting well in advance of this scheduled end time.

In some instances, client device 40 receives MSPs including data of the segment (160) after the MSP including the FDT. However, in some examples, client device 40 receives data of the segment before receiving the FDT. For example, if client device 40 tunes into the broadcast or multicast during transmission of a segment, client device 40 may begin receiving MSPs of the segment before receiving an FDT of the segment. As discussed above, however, server device 60 may send the FDT multiple times, and therefore, client device 40 may receive the FDT after receiving data of the segment, in some examples.

Client device 40 may determine, before the end time determined from the FDT, that remaining data of the segment will not be received (162). Any of the various techniques for making such a determination may be used. For example, client device 40 may determine that the remaining data will not be received based on any or all of reception of a TOI for a subsequent segment, receiving a request for the current segment from a media application (such as a DASH client), calculating an estimated time for an end of transmission of the current segment (e.g., based on a transmission rate), and/or an offset applied to a time at which a subsequent segment is to begin transmission, or the like.

In response to the determination, client device 40 may deliver the received data of the segment to a media player (164). The media player may be included within client device 40, and may comprise a streaming client. For example, the media player may correspond to DASH client 110. An eMBMS middleware, such as eMBMS middleware unit 100 (FIG. 2) may deliver the received data of the segment to the media player, using the FDT to determine locations of data for the segment to be delivered to the media player.

In this manner, the method of FIG. 13 represents an example of a method performed by a middleware unit of a client device (which also includes a streaming client), the method including receiving a first portion of data of a current segment of media data, wherein file delivery information for the current segment indicates that transmission of the data for the current segment will end at a first time, prior to the first time, determining that a remaining portion of the data of the current segment will not be received, and based on the determination, delivering at least some of the first portion of data to the streaming client.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of delivering media data from a middleware unit of a client device to a streaming client of the client device, the method comprising, by the middleware unit:
receiving a first portion of data of a current segment of media data, wherein file delivery information for the current segment indicates that transmission of the data for the current segment will end at a first time;
prior to the first time, determining that a remaining portion of the data of the current segment will not be received; and
based on the determination, delivering at least some of the first portion of data to the streaming client.

2. The method of claim 1, wherein determining comprises determining that transmission of data for the current segment has ended in response to receiving a transport object identifier (TOI) of a subsequent segment of the media data.

3. The method of claim 1, wherein determining comprises receiving one or more requests for the data of the current segment from the streaming client.

4. The method of claim 1, wherein determining comprises:
calculating an estimated time for an end of transmission of the data of the current segment; and
determining that a current time is at or later than the estimated time.

5. The method of claim 4, wherein calculating comprises calculating according to the formula:
$${T}_{0}^{′} \approx {T}_{FDT} + ⌊ \frac{seg\_dur}{MSP} ⌋ * MSP ,$$
wherein T₀′ comprises the estimated time, T_{FDT} comprises a time at which a first file delivery table (FDT) of the current segment is received or a first packet for a new TOI that includes an encoding symbol identifier (ESI) for the current segment is received, seg_dur comprises a value representative of a segment duration, and MSP represents a length of time for a multicast channel (MCH) scheduling period (MSP).

6. The method of claim 4, wherein calculating comprises calculating according to the formula:
T₀′≈T_{FDT}+seg_dur,
wherein T₀′ comprises the estimated T_{FDT} comprises a time at which a first file delivery table (FDT) of the segment is received or a first packet for a new TOI that includes an encoding symbol identifier (ESI) for the current segment is received, and seg_dur comprises a value representative of a segment duration.

7. The method of claim 1, wherein determining comprises:
determining an offset following a time at which transmission of a subsequent segment is to begin, wherein the offset is less than a segment duration, and wherein the time at which transmission of the subsequent segment is to begin plus the offset is less than a scheduled time at which transmission of the current segment is to end; and
receiving a request for the data of the current segment from the streaming client at or after the time at which transmission of a subsequent segment is to begin plus the offset.

8. The method of claim 1, further comprising:
determining an expected time at which transmission of data for the current segment will end based on a determined rate of transmission of the media data;
receiving one or more requests for the data of the current segment of the media data from the streaming client before the expected time; and
waiting until after the expected time to respond to the one or more requests.

9. The method of claim 1, further comprising:
determining an expected time at which transmission of data for the current segment will end based on a determined rate of transmission of the media data;
receiving a request for a portion of the data of the current segment from the streaming client before the expected time; and
when the requested portion has already been received, sending the requested portion to the streaming client before the expected time.

10. The method of claim 1, wherein the middleware unit comprises a multimedia broadcast multicast (MBMS) or enhanced MBMS (eMBMS) middleware unit.

11. The method of claim 1, wherein the streaming client comprises a dynamic adaptive streaming over HTTP (DASH) client, an HTTP Live Streaming (HLS) client, or a Microsoft Smooth Streaming client.

12. The method of claim 1, wherein receiving the first portion of data of the current segment comprises receiving fewer encoding symbols than are necessary to fully reconstruct the current segment, without receiving remaining encoding symbols that would be necessary to fully reconstruct the segment.

13. The method of claim 1, further comprising receiving a file delivery table (FDT) for the current segment more than once, wherein the FDT includes the file delivery information.

14. The method of claim 13, wherein receiving the FDT more than once comprises receiving the FDT as part of an ordinal-first multicast channel (MCH) scheduling period (MSP) for the current segment and as part of an ordinal last MSP for the current segment.

15. The method of claim 13, wherein receiving the FDT more than once comprises receiving the FDT as part of each MSP for the current segment.

16. The method of claim 13, wherein receiving the FDT more than once comprises receiving the FDT as part of every other MSP for the current segment.

17. The method of claim 1, further comprising receiving a file delivery table (FDT) for the current segment in an MSP other than an ordinal-first MSP for the current segment, without receiving the FDT in the ordinal-first MSP for the current segment.

18. The method of claim 1, wherein receiving the first portion of the data of the current segment comprises:
receiving a first set of encoding symbols for the current segment; and
receiving one or more repeated encoding symbols from the first set of encoding symbols for the current segment.

19. The method of claim 18, wherein receiving the repeated encoding symbols comprises receiving the repeated encoding symbols after receiving a set of repair symbols for the first set of encoding symbols.

20. The method of claim 18, wherein receiving the repeated encoding symbols comprises receiving the repeated encoding symbols before a set of repair symbols for the first set of encoding symbols.

21. The method of claim 18, wherein the repeated encoding symbols correspond to at least one of a movie fragment (moof) box of the current segment or one or more key frames of video data for the current segment.

22. The method of claim 1, further comprising reporting reception of partial segments to a server device.

23. A client device for receiving media data, the client device comprising:
a streaming client; and
a middleware unit configured to:
receive a first portion of data of a current segment of media data, wherein file delivery information for the current segment indicates that transmission of the data for the current segment will end at a first time;
determine, prior to the first time, that a remaining portion of the data of the current segment will not be received; and
based on the determination, deliver at least some of the first portion of data to the streaming client.

24. The device of claim 23, wherein to determine that the remaining portion of the data will not be received, the middleware unit is configured to determine that at least one of:
transmission of data for the current segment has ended in response to receiving a transport object identifier (TOI) of a subsequent segment;
one or more requests for the data of the current segment have been received from the streaming client;
a current time is at or later than an estimated time for an end of transmission of the data of the current segment; or
a request for the data of the current segment has been received from the streaming client at or after a time at which transmission of a subsequent segment is to begin.

25. The device of claim 23, wherein the middleware unit is further configured to:
determine an expected time at which transmission of data for the current segment will end based on a determined rate of transmission of the media data;
receive a request for a portion of the data of the current segment from the streaming client before the expected time; and
when the requested portion has already been received, send the requested portion to the streaming client before the expected time.

26. The device of claim 23, wherein the middleware unit is configured to receive a file delivery table (FDT) for the current segment more than once, and wherein the FDT includes the file delivery information.

27. The device of claim 23, wherein the middleware unit is configured to receive a file delivery table (FDT) for the current segment in an MSP other than an ordinal-first MSP for the current segment, without receiving the FDT in the ordinal-first MSP for the current segment, wherein the FDT includes the file delivery information.

28. The device of claim 23, wherein the device comprises at least one of:
an integrated circuit;
a microprocessor; and
a wireless communication device.

29. A client device for delivering media data to a streaming client of the client device, the client device comprising:
means for receiving a first portion of data of a current segment of media data, wherein file delivery information for the current segment indicates that transmission of the data for the current segment will end at a first time;
means for determining, prior to the first time, that a remaining portion of the data of the current segment will not be received; and
means for delivering, based on the determination, at least some of the first portion of data to the streaming client.

30. A computer-readable storage medium having stored thereon instructions that, when executed, cause a processor of a client device to:
receive a first portion of data of a current segment of media data, wherein file delivery information for the current segment indicates that transmission of the data for the current segment will end at a first time;
prior to the first time, determine that a remaining portion of the data of the current segment will not be received; and
based on the determination, deliver at least some of the first portion of data to a streaming client of the client device.
